(19) United States
(12) Patent Application Publication
(10) Pub. No.: US 2026/0233232 A1
(43) Pub. Date: Aug. 13, 2026

(54) LOOSENING OF GRINDING BODIES IN AN AGITATOR BEAD MILL

(71) Applicant: Bühler AG, Uzwil (CH)

(72) Inventors: Cornel FRAEFEL, Flawil (CH); Eduard NATER, Zuckenriet (CH); Thomas VERSNIK, Oberburen (CH); Achim Philipp STURM, Niederuzwil (CH)

(21) Appl. No.: 19/470,941

(22) PCT Filed: Mar. 28, 2024
(86) PCT No.: PCT/EP2024/025140

§ 371 Date: Sep. 30, 2025

(30) Foreign Application Priority Data
Mar. 31, 2023 (EP) 23165859.2

(51) Int. Cl. B02C 17/16; B02C 23/18

(52) U.S. Cl. CPC B02C 17/163; B02C 17/161; B02C 23/18

(57) ABSTRACT

The present invention provides a method for loosening a compaction or packing of grinding bodies—in particular, grinding beads—in a grinding chamber of an agitator bead mill. For this purpose, a fluid is introduced into the grinding chamber of the agitator bead mill in a temporally limited manner by means of a feed device provided for this purpose. After the grinding body compaction is dissolved, the supply of fluid is stopped again. The invention further provides a corresponding agitator mill, and a feed device for a fluid.

The present invention relates to an agitator bead mill provided with grinding bodies—in particular, to the loosening or dissolving of a compaction of the grinding bodies present in the grinding chamber of the agitator bead mill.

Agitator mills or agitator bead mills have a wide range of applications in the milling and dispersion of solids in liquids. They are used, for example, in the production of adhesives, printing inks, cosmetics, pharmaceuticals, or also for the production of raw materials (in particular, silicon) of battery pastes. In such a mill, a generally cylindrical grinding chamber bounded by a grinding chamber inner wall is formed in a grinding vessel.

The grinding stock is fed into the grinding chamber via a feed channel and is ground together with grinding bodies or auxiliary grinding bodies, such as ceramic beads, by rotation of an agitator. Such agitator bead mills can have a rotor that rotates inside the grinding chamber and is optionally equipped with agitator implements on the rotor and optionally also on the vessel wall. This type of agitator bead mill can be arranged such that the central longitudinal axis of the grinding chamber extends in the vertical direction during operation. Such agitator bead mills having agitator implements on the rotor and possibly also on the vessel wall are also used in a horizontal arrangement of the central longitudinal axis of the grinding chamber. Another type of agitator bead mill, to which the present invention can be applied, has an agitator shaft arranged about the central longitudinal axis and rotatable about said axis, to which a plurality of grinding disks are attached. These are often arranged in operation such that the central longitudinal axis extends in the horizontal direction.

After processing, the grinding stock is removed from the grinding chamber through a product outlet.

When the grinding stock is removed from the grinding chamber after the grinding operation is completed, the grinding bodies remain in the grinding chamber when the agitator is stationary. In this case, there is a risk that the grinding bodies clump together, i.e., form a compaction, in the positions where they remain under the effect of gravity when the mill is stationary. It is then possible that the grinding body charge in the grinding chamber blocks the rotor and makes it impossible to restart the rotor.

In the past, attempts have been made to eliminate such a compaction in that a small quantity of the grinding bodies was removed with a piston device. However, such a process is very complicated and cannot be carried out in all types of mills. A device used for this purpose is described, for example, in DE 2 051 003.

DE2 230 766 A1 describes a method and a device for grinding solids contained in a liquid, wherein the liquid flows from a storage tank to an attritor and back. The attritor contains grinding means, such as beads, which are prevented by a screen from entering a line arranged between the attritor and the storage tank.

CN 216778978 U describes a vertical bead mill having a detachable inner cylinder, wherein a filter screen for retaining grinding beads is arranged on the inner cylinder.

It is therefore an object of the present invention to provide a simple means for loosening or dissolving a compaction of the grinding bodies in an agitator bead mill in order to release a blockage of the rotor and allow the mill to start up.

This object is achieved by the features of the independent claims; the dependent claims define preferred embodiments of the present invention.

The present invention provides a method for loosening a compaction or packing of grinding bodies—in particular, grinding beads—in a grinding chamber of an agitator bead mill. For this purpose, a fluid is introduced into the grinding chamber of the agitator bead mill in a temporally limited manner by means of a feed device provided for this purpose. After the grinding body compaction is dissolved, the supply of fluid is stopped again. The introduced fluid can remain in the grinding chamber and can be flushed out together with the product during subsequent operation. For this purpose, the fluid should be product-compatible.

The introduction of the fluid—in particular, the fluid flow—allows the grinding bodies to be brought out of their position assumed in the compaction. The grinding body compaction can be disturbed and thus loosened and at least partially dissolved by wetting and/or lubricating the grinding body outer surfaces.

The fluid can be a liquid, such as an organic solvent or water, a gas, such as nitrogen, air, or oxygen, or a liquid/gas mixture. The fluid is preferably water.

The method according to the invention can be carried out when the agitator bead mill is at a standstill. Once the fluid has been introduced and the grinding body compaction has been loosened, the agitator bead mill can then be started while the fluid is located in the grinding chamber.

The method can also be carried out when the agitator bead mill is stopped, viz., when the rotational speed of an agitator arranged in the grinding chamber is reduced. In this case, the fluid is introduced into the grinding chamber prior to standstill.

The method according to the invention can be carried out automatically, wherein the fluid is introduced into the grinding chamber in an automated manner before the agitator bead mill is started and/or stopped.

Preferably, the fluid flows through a grinding body retaining device—in particular, a screen—as it is introduced into the grinding chamber.

The pressure at which the fluid is introduced into the grinding chamber is preferably below a maximum pressure—for example, below 3 bar.

The amount of fluid introduced is preferably at least 2% and at most 90% of the grinding chamber volume.

The invention also provides an agitator bead mill. The agitator bead mill typically has a grinding chamber arranged in a grinding vessel, a product inlet for introducing grinding stock into the grinding chamber, a product outlet for removing the ground grinding stock, an agitator rotatably arranged in the grinding chamber, and a plurality of grinding bodies arranged in the grinding chamber. The agitator bead mill according to the invention further has a feed opening for introducing a fluid into the grinding chamber and a feed device that can be connected to the feed opening and is configured to introduce the fluid into the grinding chamber. An existing opening, e.g., an opening for complete emptying of the grinding chamber, including the grinding bodies, can also be used as the feed opening for the fluid. The feed device for the fluid is preferably arranged in the lower region of the grinding chamber.

The agitator bead mill can also have a control device for automatically introducing the fluid into the grinding chamber before the agitator is started and/or stopped.

The diameter of the grinding bodies is preferably between 0.03 and 2.0 mm—preferably between 0.05 and 0.8 mm.

The feed device for the fluid preferably has a grinding body retaining device—in particular, a screen.

The grinding bodies should be at least 20%, and preferably between 30% and 50%, larger in diameter than the smallest dimension of a passage of the grinding body retaining device. The grinding body retaining device is preferably made of hardened steel—preferably of ceramic or a hard metal.

In order to be able to retrofit an existing agitator bead mill, the invention also provides a feed device for connection to a grinding chamber of an agitator bead mill for introducing a fluid into the grinding chamber. The feed device has a valve, a feed line connected to the valve, and a grinding body retaining device.

The invention is described in more detail below with reference to the accompanying figures, wherein

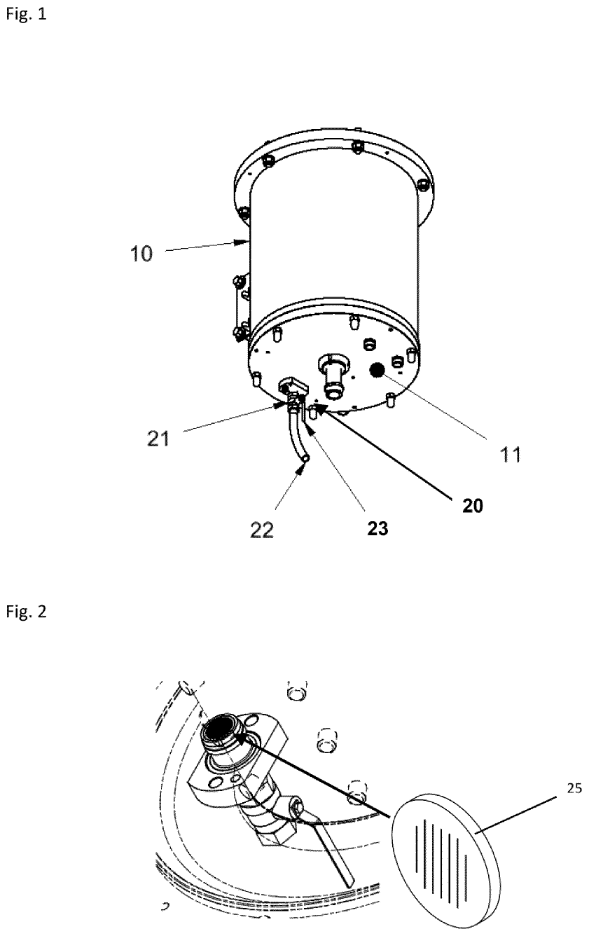

FIG. 1 shows an underside of an agitator bead mill with a fluid connection according to the present invention, and

FIG. 2 schematically shows the fluid connection with a screen in the feed opening.

The grinding vessel 10 of an agitator bead mill can be seen in FIG. 1. In the embodiment shown, the cylindrical grinding vessel 10 with an internal grinding chamber is arranged such that the central longitudinal axis is oriented vertically. An additional connection is indicated by the arrow at the lower end, via which a fluid can be introduced into the agitator bead mill and in particular into the grinding chamber of the agitator bead mill.

Due to gravity, the grinding bodies accumulate at the lower end of the vertically oriented agitator bead mill when the mill is at a standstill. In the lower end surface 11 of the grinding vessel 10, an opening is provided which can be used as a feed opening for a fluid. A feed device 20, through which a fluid can be introduced into the grinding chamber, is arranged at the opening. In addition, FIG. 1 shows a valve actuator 23 of the feed device 20, which valve actuator allows the valve 21 for the fluid supply to be opened or closed. The feed device 20 also has a tube 22 for guiding the fluid from a fluid reservoir (not shown) to the feed opening.

The fluid, e.g., a liquid, such as water or an organic solvent, or a gas, such as nitrogen, air, or oxygen, can be introduced through the fluid access into the grinding chamber of the agitator bead mill—preferably in a region where the compaction of the grinding bodies occurs. As shown in the figure, this can be on the lower end surface 11 on the underside of the grinding vessel 10. However, a corresponding connection to a side wall of the grinding chamber is also possible, but preferably, even in the case of an agitator bead mill having a horizontally oriented central longitudinal axis, in the lower portion of the grinding vessel 10.

By introducing the fluid, the grinding bodies can be brought out of their assumed position. The grinding body compaction can be disturbed and thereby at least partially dissolved by additionally wetting or lubricating the grinding body outer surfaces. The agitator bead mill can thus be started and operated again properly. After the start, the fluid introduced preferably remains in the grinding chamber and is discharged from the grinding chamber together with the ground grinding stock during subsequent operation. For this reason, the fluid introduced should be compatible with the product to be ground, i.e., it should not contaminate or otherwise render the product to be ground unusable.

Compaction of grinding bodies can in particular occur when the machine is at a standstill, and there is no grinding stock in the grinding chamber. The method according to the invention is therefore often used after a standstill of the agitator bead mill or the rotor—in particular, before the machine is filled with grinding stock and restarted.

However, the method can advantageously also be used during the stopping operation of the agitator bead mill, when the grinding stock has usually already been drained. If the rotor speed is reduced before stopping, before the agitator bead mill is stopped, the rotor may stop suddenly due to unfavorable grinding body positioning or grinding body compaction. In order to counteract compaction of the grinding bodies in this case as well, it has been found to be useful to introduce fluid according to the method according to the invention during the reduction of the rotational speed as of a certain rotational speed—for example, 600 rpm. Use of the method according to the invention is also possible during the rinsing operation of the grinding chamber with the rotor running.

The fluid can be supplied by manually opening the valve. However, it is also possible to supply the fluid automatically by means of a control device when the agitator mill is started or stopped. In this case, fluid can be automatically injected during the starting operation before the agitator is started up, and the agitator can be started up with a predetermined delay after the fluid is supplied. Likewise, when the fluid supply is stopped, the fluid can be automatically supplied at a predetermined rotational speed.

When carrying out the method according to the invention, the fluid is introduced in a constant or pulsating manner over a limited period of time. The pressure of the fluid to be introduced is of course below the maximum permissible pressure of the grinding chamber—generally at most approximately 3 bar. The amount of fluid introduced is limited, and/or is monitored when the fluid is introduced. In general, small amounts of fluid are already sufficient to dissolve a compaction. For example, 2% of the grinding chamber volume may already be sufficient. However, a quantity of fluid up to approximately 90% of the grinding chamber volume may also be introduced.

In order to ensure that the grinding bodies remain in the grinding chamber during the execution of the method according to the invention, the feed opening for the fluid is provided with a grinding body retaining device—in particular, a screen. The openings of the screen should be smaller than the diameters of the grinding bodies used. If, for example, the diameter of the grinding bodies is 0.1 mm, the slots of the screen should have a width of, for example, 0.03 to 0.05 mm. Particularly preferably, the method according to the invention can be used when small grinding bodies are used, wherein the diameter of the grinding bodies is then between 0.03 mm and 2.0 mm—preferably between 0.05 mm and 0.8 mm. The screen can be made of hardened steel or preferably also of ceramic, including a hard metal.

By way of example, FIG. 2 shows the use of a screen 25 on the fluid feed opening. The screen 25 is preferably arranged flush with the inner surface of the grinding chamber—in the embodiment shown, on the base plate of the grinding vessel. This is the region where grinding body compaction often occurs due to gravity.

The fluid is introduced into the grinding chamber of the agitator bead mill through the opening provided for this purpose from a feed line—generally a hose 22—via a feed valve 21 and through the screen 25, or generally a grinding body retaining system, such as a screen or nozzle. The openings provided in the grinding chamber according to the invention, i.e., the feed opening of the fluid, the product inlet, the product outlet, the grinding body filling opening, the grinding body emptying opening into or out of the grinding chamber, can be realized by different openings in the grinding chamber. However, it is also possible and within the scope of protection of the present invention to use the feed opening of the fluid, by removing the screen, to completely empty the grinding chamber and thus also to remove the grinding bodies from the grinding chamber. It is even conceivable to use an existing feed or drainage opening in the grinding chamber for the method according to the invention. A feed device 20, which has a feed line, a valve, and a grinding body retaining device, i.e., for example, the screen, must then be connected to this existing opening if necessary.

1. A method for loosening a compaction or packing of grinding bodies in a grinding chamber of an agitator bead mill, wherein a fluid is introduced into the grinding chamber of the agitator bead mill in a temporally limited manner by means of a feed device (20) provided for this purpose, and, after the grinding body compaction is dissolved, the supply of fluid is removed stopped again.

2. The method according to claim 1—, wherein the grinding bodies are brought out of their position assumed in the compaction by introducing the fluid—in particular, by the fluid flow—and the grinding body compaction is loosened and at least partially dissolved by wetting and/or lubricating the grinding body outer surfaces.

3. The method according to claim 1, wherein the fluid is a liquid, such as an organic solvent or water, a gas, such as nitrogen, air, or oxygen, or a liquid/gas mixture, wherein the fluid is preferably water.

4. The method according to claim 1, wherein the agitator bead mill is at a standstill before the fluid is introduced and is started, after the fluid is introduced, while the fluid is located in the grinding chamber.

5. The method according to claim 1, wherein, to stop the agitator bead mill, the rotational speed of an agitator mill arranged in the grinding chamber is reduced, and the fluid is introduced into the grinding chamber before the standstill.

6. The method according to claim 1, wherein the fluid is introduced into the grinding chamber in an automated manner before the agitator bead mill is started and/or stopped.

7. The method according to claim 1, wherein the fluid flows through a grinding body retaining device—in particular, a screen—during introduction into the grinding chamber.

8. The method according to claim 1, wherein the pressure at which the fluid is introduced into the grinding chamber is below a maximum pressure—for example, below 3 bar.

9. The method according to claim 1, wherein the amount of fluid introduced is at least 2% and at most 90% of the grinding chamber volume.

10. An agitator bead mill having
a grinding chamber arranged in a grinding vessel,
a product inlet for introducing grinding stock into the grinding chamber, a product outlet for removing the ground grinding stock,
an agitator rotatably arranged in the grinding chamber, and
a plurality of grinding bodies arranged in the grinding chamber, wherein the agitator bead mill further has a feed opening—preferably arranged in the lower region of the grinding chamber—for introducing a fluid into the grinding chamber, and a feed device that can be connected to the feed opening, which feed device is configured to introduce the fluid into the grinding chamber.

11. The agitator bead mill according to claim 10, further having a control device for automatically introducing the fluid into the grinding chamber before the agitator is started and/or stopped.

12. The agitator bead mill according to claim 10, wherein the diameter of the grinding bodies is between 0.03 and 2.0 mm—preferably between 0.05 and 0.8 mm.

13. The agitator bead mill according to claim 10, wherein the feed device for the fluid has a grinding body retaining device—in particular, a screen—wherein the grinding body size is preferably at least 20%, and even more preferably between 30% and 50%, larger in diameter than the smallest dimension of a passage of the grinding body retaining device.

14. The agitator bead mill according to claim 13, wherein the grinding body retaining device is made of hardened steel—preferably of ceramic or a hard metal.

15. A feed device for connection to a grinding chamber of an agitator bead mill for introducing a fluid into the grinding chamber, having a valve, a feed line connected to the valve, and a grinding body retaining device.

16. The method according to claim 2, wherein the fluid is a liquid, such as an organic solvent or water, a gas, such as nitrogen, air, or oxygen, or a liquid/gas mixture, wherein the fluid is preferably water.

17. The method according to claim 3, wherein the agitator bead mill is at a standstill before the fluid is introduced and is started, after the fluid is introduced, while the fluid is located in the grinding chamber.

18. The agitator bead mill according to claim 11, wherein the diameter of the grinding bodies is between 0.03 and 2.0 mm—preferably between 0.05 and 0.8 mm.

19. The agitator bead mill according to claim 11, wherein the feed device for the fluid has a grinding body retaining device—in particular, a screen—wherein the grinding body size is preferably at least 20%, and even more preferably between 30% and 50%, larger in diameter than the smallest dimension of a passage of the grinding body retaining device.

20. The agitator bead mill according to claim 12, wherein the feed device for the fluid has a grinding body retaining device—in particular, a screen—wherein the grinding body size is preferably at least 20%, and even more preferably between 30% and 50%, larger in diameter than the smallest dimension of a passage of the grinding body retaining device.
